(19) United States
(12) Patent Application Publication
(10) Pub. No.: US 2011/0163095 A1
(43) Pub. Date: Jul. 7, 2011

(54) CLOSABLE APERTURE FOR RETROFITTING TO A CONTAINER

(75) Inventor: Avner Kitai, Kadima (IL)

(73) Assignee: Pour-All Technologies Ltd., Pardes-Hanna (IL)

(21) Appl. No.: 13/061,552

(22) PCT Filed: Sep. 2, 2009
(86) PCT No.: PCT/IL09/00849

§ 371 Date: Mar. 1, 2011

(30) Foreign Application Priority Data
Sep. 2, 2008 (IL) 193858

(51) Int. Cl. B65D 51/00; F16B 47/00; B23P 17/00

(52) U.S. Cl. 220/212; 24/304; 29/401.1

(57) ABSTRACT

A separately vendible reclosing means for attaching to a sachet comprising a framework with a permanent adhesive on a first side thereof for adhering to the sachet and a lid attached to the framework having a closable aperture therein. A method of converting a hermetically sealed sachet into a reusable container comprising the reclosing means is also described.

### FIELD OF THE INVENTION

The present invention relates to disposable packaging and containers, particularly to vacuum packaging for consumerables, and to ways of reusing such packaging after opening.

### BACKGROUND OF THE INVENTION

Many products are vended in cardboard boxes, plastic sachets and paper, card or plastic packages of various types. Where the entire contents of the container are used at once, the container can be hermetically sealed prior to opening, keeping the contents safe from degradation. The best example perhaps, of packaging of this type, is the tin-plated steel can used for baked beans and other foodstuffs, which, provided the container is not dented or punctured, is able to keep contents fresh for extended periods.

Another type of container having similar properties is the plastic sachet widely used for potato crisps and other snacks, for frozen vegetables, dried rice and other products, mostly food stuffs. Usually such sachets have plastic welded seams.

When opened in the conventional manner, by pulling apart the seam at one end of the bag, the contents can be eaten from the bag or sachet. This is typically the case with single portion bags of potato crisps and other snack foods. For parties, party sized sachets are typically emptied into bowls and the like.

Where the contents of the sachet are more than required for consumption at once, the contents have to be transferred into a sealable container, such as a plastic box with a snap on lid, or the opened sachet has to be reclosed somehow.

Transferring the contents of sachets to utility boxes requires subsequent opening of the boxes to view the contents thereof or labeling thereof. Details such as ingredients, sell-by-or manufacturing date, allergic warnings etc. are lost. Consequently, it is preferable to reseal the partially empty sachet, thereby keeping fully documented contents available for further use.

For storage within the sachet, and reclosing same, wire ties are the most convenient solution. Whilst not hermetically sealed, the sachet is at least tightly closed, and the contents are protected from ants and the like, and degradation of contents through drying out or adsorption of strong smells etc. is generally delayed by a few days. Wire ties are fiddly to use however, and children, the elderly and the arthritic often have problems with opening and closing wire ties.

When used with frozen vegetables and the like, non-hermetic sealing is less problematic in that the frozen state of the vegetable helps prevent degradation. However, the large surface area of the contents, serves as a favorite location for ice crystals to form and as the freezer is opened and closed, warm moist air enters the freezer and, on cooling, more and more ice is added to the content of the opened back of frozen vegetables since the large surface area thereof assists in deposition of ice crystals (frost) from the air.

Folding or rolling over the open end of the bag and applying some kind of clip or clothes peg is also a tried and tested solution that is good for keeping the contents of an opened bag or sachet from spilling out, and is useful for dried rice and similar, robust dry particulate type products. Where contents require hermetic sealing for long term storage, the quality of the contents of bags closed in this manner lasts at best for a few days. The above problems are quite well known and a number of partial solutions have been developed for particular applications.

For example, Japanese Patent Publication Number JP10024972 titled “Label for Lid of Packaging Body” is directed to improved user convenience for packages of moist wipes, such as are used for cleaning a baby whilst changing its diaper, or for makeup removal.

For such applications, a lid label for a package body having a coating of pressure-sensitive adhesive on its rear side that covers and tightly seals the take-out opening of the package body is provided. In the inner part of the lid label, a label slit in the form of an open loop which is open in a peeling direction is made, thereby forming a label peel part which covers the take-out opening and can repeatedly unseal/seal it, and a label frame which remains on the package body when the label peel part is peeled. One feature of this type of solution is that the framework with removable lid is vended together with the contents of the sachet.

International Patent Application Number WO9318988 titled “Reclosable Package for Oil Impregnated Clothes.” relates to a set of products to be packed in particular oil-impregnated cloths, and enclosed in an outer package. On the top side of the set is fixed a synthetic piece with an upper covering panel, cap or simple frame unit, and with a closable aperture from which the material is taken and which is provided with a closing lid or cap. An outer cladding layer is fixed and sealed off from the underlying layer by means of a seam, with a section which extends outwards around the aperture, and the enclosed region of the set of products is simultaneously sealed off. The cladding layer is in the form of a tubular bag, a seamed bag or a bag with a fixed base. Opening aids provided around the aperture facilitate tearing and the removal of the cladding section in that area. A groove can be made in the cladding between two longitudinal ridges or in a notched line in the synthetic piece; alternatively, the latter can be opened up along an embossed line by means of a projecting lug and removed via a low-adhesion secondary inner seal. The large covering lid can then be opened and closed.

European Patent Application Number EP0370982 titled “Reclosing Arrangement For Squarely Cross Cut Containers” describes a reclosing arrangement for a container of cardboard, plastic or sheet metal and of the type which is adapted to be connected to a lid frame having an all around extending groove, whereby a cross cut top part of the container is introduced in said groove of the lid frame and is secured in this position by means of glue, wax, hot-melt or a similar material, whereby at least the inner wall of the groove is conically tapering in the direction towards the bottom of the connection groove. At least the inner wall of the connection groove is formed with several ribs extending mainly in the direction of introducing the container in the groove, and the ribs are formed substantially triangularly with the longest side of the rib triangle integral with the inner side of the groove.

This type of arrangement provides a solution to containers having specific geometries, and is not a utility solution for a wide variety of bags, sachets and the like.

U.S. Pat. No. 5,044,776 titled “Resealable Closure System” provides a resealable closure system for a non-rigid product bag. The resealable closure system is generally an adhesive strip affixed to a non-rigid product bag which allows the bag to be reclosed a multiple number of times. The resealable closure system has a permanent adhesive on the first surface such that the system can be affixed to a non-rigid product bag and positioned between the top and the bottom of the bag. The second surface of the bag has a controlled peel adhesive disposed thereon. A release liner containing perforations cut essentially perpendicular to the system's length cover the controlled peel adhesive until use. These perforations permit defined segments of the release liner to be removed to expose new areas of adhesive thereby providing fresh securing sites for subsequent closure and sealing of the bag.

Here, the seam is essentially resealed. The solution is only applicable to sachets designed to be opened along a seam. The number of times the bag can be opened or closed is limited in that fresh areas of non-resealable adhesive are used each time.

Pending Application Number USSN 20050000965 titled “Container Provided With Resealable Cover Adhered to the Container by an Adhesive” relates to a resealable container for storing food, that comprises an adhesive providing releasable and resealable bond between a closure and a lip of a receptacle. This type of solution and many others like it, provide a resealable container, not a separately vended sealing means for non resealable containers.

Indeed, perhaps the best known solution of this type is the heavy polyethylene type reusable bags having mating strips on each side of the mouth thereof that can be interlocked by applying a pinching pressure and running the pinched together fingers back and forth along the seam.

Certain foodstuffs, such as cheese or sliced meat, are sometimes sold in vacuum sealed containers that once opened can be resealed by a reusable adhesive that is exposed when first opening such containers. For example, JP2004106878 titled “Container and Resealable Packaging Container” provides a container which is formed by molding a multiple layer sheet for which a base material is laminated on a co-extruded multiple layer film. In this case, for the co-extruded multiple layer film, a surface resin layer, an adherent resin layer containing a rubber-like thermoplastic resin, an adhesion imparting agent, a coloring agent, and a heat-sealing resin layer are laminated in order. Then, when the resin layer and a heat-sealing resin layer of the lid member are superposed and heat-sealed, the lid member is peeled off and the adherent resin layer is exposed on the container side or the lid member side under a resealable adherent state at the heat-sealing part for this container. For such a container and resealable packaging container, the opening of the container is sealed by heat-sealing with the lid member.

Canadian Patent Number CA2290560 titled “Resealable Closure and Method of Making Same” relates to a flexible package for a product that includes a resealable closure for resealing one portion of the package to an opposing portion of the package. The resealable closure is formed by applying a layer of pressure-sensitive adhesive on the inner surface of at least one of the opposing portions of the package, and applying a layer of cohesive to the inner surface of both of the opposing portions so that the pressure-sensitive adhesive layer is covered by a layer of cohesive. The pressure-sensitive adhesive has a greater affinity for adhering to the cohesive than to the inner surface of the package. Accordingly, pressure-sensitive adhesive is detached from the inner surface of the package when the opposing portions are pulled apart, and the portions can be resealed by pressing the portions back together to cause the pressure-sensitive adhesive to adhere to the portion from which is was detached.

Published PCT Application Number WO03029100 titled “Container Provided with a Resealable Cover Adhered to the Container by an Adhesive” is directed to providing a resealable container comprising an at least semi rigid receptacle with an opening, a lip surrounding the opening, a closure for closing the opening, and an adhesive. The adhesive provides a releasable and resealable bond between the closure and the lip, substantially all of the adhesive remaining on one of the closure or the lip when the bond is released.

Thus the idea of a closure being attachable to a container via a permanent adhesive and having a second adhesive that can be reused is known. Zipper fasteners, plastic tracks and other closures are also widely used for resealing packages.

However, none of the above solutions are ideal incases where non-hermetic sealing can and will degrade the contents of the packaging, especially when the contents are used over lengthy periods. Often, vendors are loath to provide packaging with only partially effective sealing as such solutions can render them responsible for damage to the packaging's contents.

There is thus a need for a closure means that can be retrofitted to sachets and/or bags of dried food, particularly to dried food sold as hermetically sealed, to allow access to contents thereof and resealing each time the contents are accessed to prevent such contents from being spilled and/or to slow moisture uptake and degradation mechanisms. The present invention addresses these needs.

### SUMMARY OF THE INVENTION

It is an object of embodiments of the invention, to provide a closing means and method for resealing sachets and bags.

An embodiment of the invention is directed to a retrofittable resealing means for resealing packets of dry goods such as packets of rice, dried pasta, dried legumes, and the like.

One aspect of the invention is directed to providing a separately vendible item comprising a patch having a self-adhesive frame and a zipper-type multiple sealing opening for retrofitting to an existing container such as a sachet or bag.

In a first aspect, a separately vendible resealing means for attaching to a sachet is provided, the separately vendible resealing means comprising a framework with a permanent adhesive on a first side thereof for adhering to the sachet and a lid appended to the framework.

In one embodiment, the lid is permanently attached to the framework, and includes a zipper closure.

In a second embodiment, the lid is permanently attached to the framework, and includes a slit-like aperture having mating edges therealong that are sealable by pressing together.

In a third embodiment, the separately vendible resealing means for attaching to a sachet comprises a framework with a permanent adhesive on a first side thereof for adhering to the sachet, and a pealable lid being appended to the framework via a multiuse contact adhesive for replaceably removing and replacing the lid to the framework.

In some embodiments, the permanent adhesive is water activated and adhesion thereof to the sachet requires moistening with water.

Alternatively, the permanent adhesive is a single use contact adhesive and the separately vendible resealing means further comprises a release layer for protecting the contact adhesive such that application of the separately vendible resealing means to the sachet requires removing the release layer and pressing the contact adhesive coated side of the framework onto the sachet.

Optionally, the framework is stamped from a laminar sheet.

Typically, the laminar sheet comprises materials selected from the group comprising cellulose fibers, artificial fibers and polymers.

Alternatively, the framework is injection molded from a polymer.

In some embodiments, the pealable lid comprises a polymer sheet and/or a cellulose based paper.

Typically, the multiuse contact adhesive is provided on upper surface of the framework and the lid is releasably adherable thereto.

Optionally, the multiuse contact adhesive is provided at least around the perimeter of the lid allowing the lid to be attachable to the framework thereby.

Typically, contents of the sachet are selectable from the group comprising wet wipes, tissues, breakfast cereal, soup powder, dried pasta, spices, legumes, foodstuffs, flakes of soap, flakes of detergent and snack-foods.

In a second aspect, the present invention is directed to providing a method of converting a hermetically sealed sachet into a reusable container by the steps of (b) adhering a self-adhesive framework to a surface thereof; (d) forming an aperture in the surface of the sachet within the framework, and (e) applying a lid to the framework to cover and seal the aperture.

Optionally, the method comprises an initial step (a) of removing a release layer from the framework to expose a self adhesive layer thereof.

Alternatively, the method comprises an initial step (a) of activating a self adhesive layer of the framework by dampening.

Optionally, the method comprises an additional step (c) of pealing back the lid from the framework to allow formation of an aperture in the surface of the sachet thereunder.

Alternatively, the method comprises an additional step (c) comprising removing a release layer from the framework to expose the self adhesive layer thereof.

Optionally, the lid is integral with the framework and comprises mating surfaces that may be zipped closed.

Optionally, the mating surface comprises a zip.

Alternatively, the mating surfaces comprise interlocking raised tracks.

The term sachet is used loosely to imply various types of sealed packages and containers, particularly hermetically sealed bags and the like.

### BRIEF DESCRIPTION OF FIGURES

For a better understanding of the invention and to show how it may be carried into effect, reference will now be made, purely by way of example, to the accompanying Figures, wherewith it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

FIG. 1 is an expanded isometric projection of a retrofittable reclosing means for attaching to a sachet or the like;

FIG. 2 is schematic cross-section of the retrofittable reclosing means of FIG. 1, retrofitted to a sachet;

FIG. 3 is an isometric projection of a retrofittable reclosing means having a peal back lid attached to a sachet or the like;

FIG. 4 is an isometric projection of a retrofittable reclosing means including a zipper closure;

FIG. 5 is an isometric projection of a retrofittable reclosing means including interlockable pressure ridges;

FIG. 6 is an isometric projection of a retrofittable reclosing means including interlockable pressure ridges such as that shown in FIG. 5, further comprising a knife or cutter attached to the fastening means for piercing a substrate thereunder, for opening a hermetically sealed package after fastening a retrofittable reclosing means thereto.

FIG. 7 is a flowchart showing how a retrofittable closure device of the invention may be retrofitted to a sachet.

### DESCRIPTION OF PREFERRED EMBODIMENTS

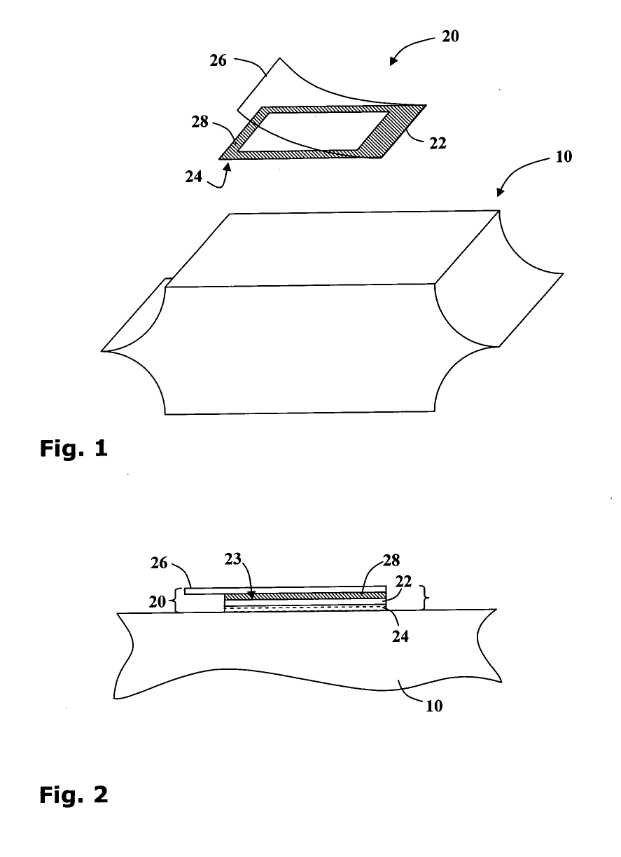

With reference to FIG. 1, a separately vendible closure means 20 for attaching to a sachet 10 is shown. The separately vendible closure means 20 consists of a framework 22 with a permanent adhesive 24 on a first side, i.e. the underside of framework 22, for adhering to sachet 10, and a pealable lid 26 appended to framework 22 via a multiuse contact adhesive 28 for replaceably removing and replacing lid 26 on framework 22.

In some embodiments, permanent adhesive 24 includes a dry water activated paste or glue such that adhesion thereof to sachet 10 requires moistening permanent adhesive 24 with water.

Permanent adhesive 24 is a single use contact adhesive. Separately vendible closure means 20 is provided with a release layer for protecting contact adhesive 24 such that application of separately vendible resealing means 20 to sachet 10 requires removing the release layer and pressing the contact adhesive 24 coated side of framework 22 onto the side of sachet 10.

FIG. 2 is a schematic cross-section of separately vendible resealing means 20 attached to sachet 10. Separately vendible resealing means 20 is not drawn to scale so that the various films and layers of adhesive are more clearly seen.

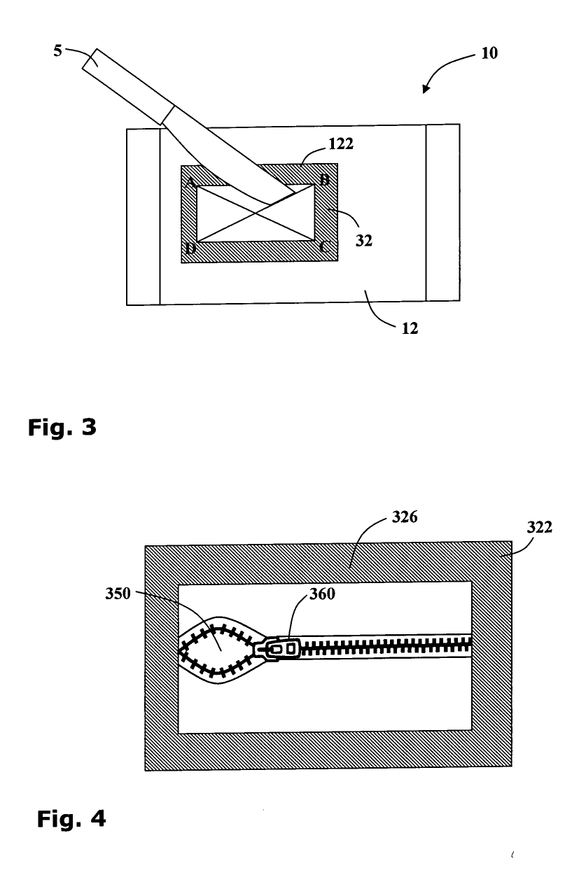

Typically, but not exclusively, framework 22 defines a substantially rectangular or oblong opening, perhaps with rounded corners. With reference to FIG. 3, when such a rectangular framework 122 is stuck in position onto the side 12 of sachet 10, the wall of sachet 10 may be pierced within framework 122, by cutting an X through side 12, with a knife 5, perhaps, by cutting across from one corner A to the diagonally opposite corner C, and again from B to D, to form a star trap. An opening may alternatively be formed by running knife 5 around the inside of framework 122, to provide a substantially rectangular aperture, or indeed one having a different shape if the framework has a different shape.

Framework 22 (122) itself may be stamped out from a laminar sheet material such as a cardboard or plastic sheet, made of cellulose fibers and/or artificial fibers and/or polymers. Where fabricated from plastic, framework 22 (122) may alternatively be injection molded from a polymer.

Pealable lid 26 may be fabricated from a polymer sheet material, being cut or stamped therefrom. Alternatively, pealable lid 26 may comprise a cellulose based paper, with or without lamination. Multiuse contact adhesive 28 is provided on upper surface 23 of framework 22 and lid 26 is releasably adherable to framework 26 thereby.

In various configurations for different types of goods, multiuse contact adhesive 28 is provided at least around the perimeter of framework 22, such as on a flange 32 therearound, allowing lid 26 to be attachable to framework 22 thereby.

With reference to FIG. 4, in an alternative embodiment, a lid 326 is permanently attached to a framework 322 but has a sealable mouth 350 which is closable by a zipper 360.

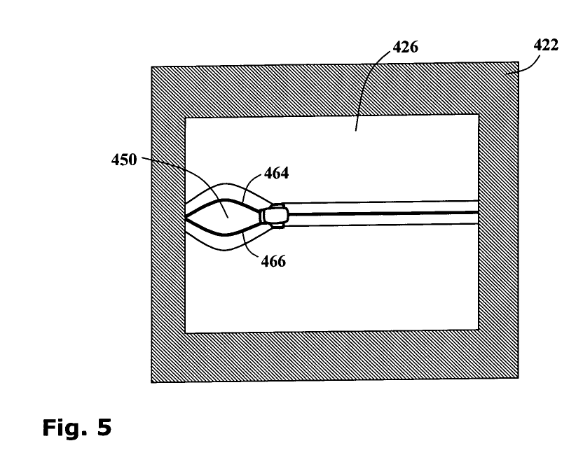

With reference to FIG. 5, in an alternative embodiment, a lid 426 is permanently attached to a framework 422 but has a sealable mouth 450 which is closable by mating ridges 464 and 466, such as sometimes provided in more expensive plastic bags.

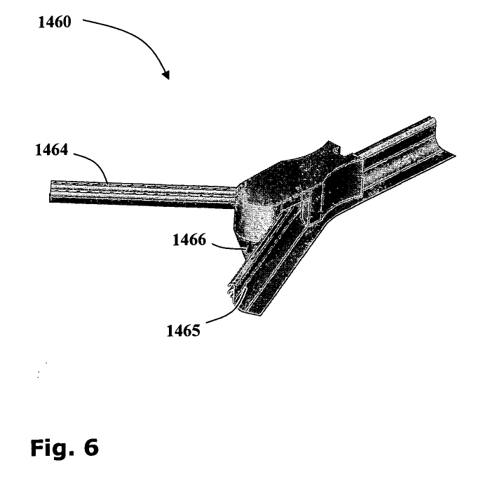

As shown in FIG. 6, a zipper closure 1460 may be provided to zip closed the mating ridges 1464 and 1465. The zipper closure 1460 may usefully include an integral knife 1466 for piercing the surface of a sachet to which an embodiment of the invention is retrofittable. Although shown as part of the zipper of a mating ridges type of plastic zip, it will be appreciated that an integral knife may be retrofitted to other fastening means described herein.

The various embodiments may be used to provide a retrofittable, reclosable solution for closing sachets and packets of various types, such as sachets or packets of wet wipes, tissues, breakfast cereal, soup powder, dried pasta, spices, legumes, foodstuffs, flakes of soap, flakes of detergent or snack-foods.

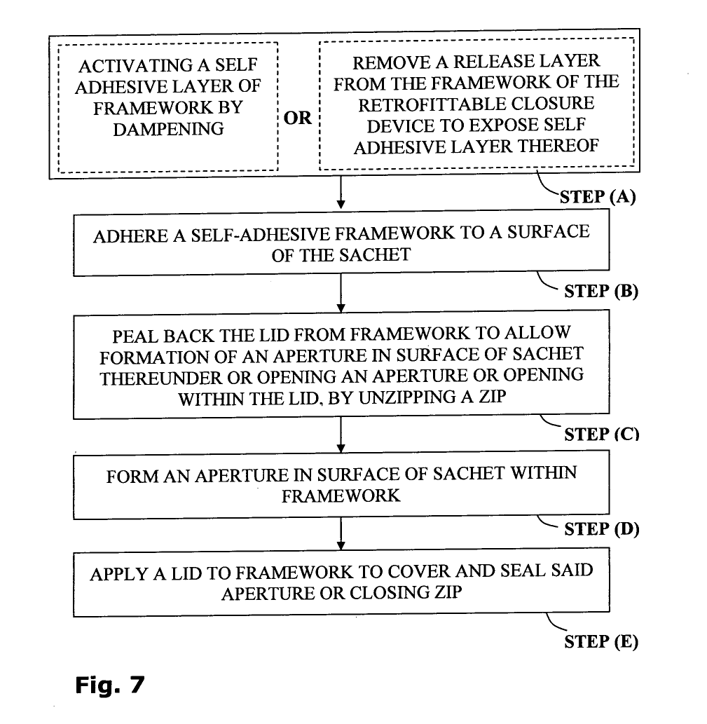

With reference to FIG. 7, a method of converting a hermetically sealed sachet into a reusable container includes the steps of: (a) optionally removing a release layer from a framework of a retrofittable closure device to expose a self adhesive layer thereof or optionally activating a self adhesive layer of the framework by dampening; (b) adhering a self-adhesive framework to a surface of the sachet; (c) pealing back a lid from the framework to allow formation of an aperture in the surface of the sachet thereunder or opening an aperture or an opening within the lid, by unzipping a zip, (d) forming an aperture in the surface of the sachet within the framework, and (e) applying a lid to the framework to cover and seal the aperture or closing zip.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A separately vendible reclosing means for retrofitting to a previously purchased sachet, said separately vendible means comprising:
a framework with a permanent adhesive on a first side thereof for adhering to the sachet and a lid attached to said framework having a closable aperture therein.

2. The separately vendible reclosing means of claim 1, comprising a lid permanently attached to said framework and comprising an opening surrounded by a closable means.

3. The separately vendible reclosing means of claim 2, wherein said closable means comprises mating ridges on each side of the opening.

4. The separately vendible reclosing means of claim 2, wherein said closable means comprises a zipper and zipper tracks on each side of the opening.

5. The separately vendible reclosing means of claim 1, further comprising an integral knife for piercing an aperture in the sachet.

6. The separately vendible reclosing means of claim 1, for attaching to a sachet, said separately vendible means comprising:
said framework with a permanent adhesive on a first side thereof for adhering to the sachet, and a pealable lid appended to said framework via a multiuse contact adhesive for replaceably removing and replacing said lid to said framework.

7. The separately vendible reclosing means of claim 1, comprising a removable lid adhered to said lid via a multiuse contact adhesive for replaceably removing and replacing said lid to said framework.

8. The separately vendible reclosing means of claim 1, wherein said permanent adhesive is water activatable and adhesion thereof to the sachet requires moistening with water.

9. The separately vendible resealing means of claim 1, wherein said permanent adhesive is a single use contact adhesive and said separately vendible resealing means further comprises a release layer for protecting said contact adhesive such that application of said separately vendible resealing means to the sachet requires removing said release layer and pressing the contact adhesive coated side of said framework onto the sachet.

10. The separately vendible resealing means of claim 1, wherein said framework is stamped from a laminar sheet.

11. The separately vendible resealing means of claim 10, wherein the laminar sheet comprises materials selected from the group comprising cellulose fibers, artificial fibers and polymers.

12. The separately vendible resealing means of claim 1, wherein said framework is injection molded from a polymer.

13. The separately vendible resealing means of claim 6, wherein said pealable lid comprises a polymer sheet.

14. The separately vendible resealing means of claim 6, wherein said pealable lid comprises a cellulose based paper.

15. The separately vendible resealing means of claim 6, wherein said multiuse contact adhesive is provided on the upper surface of said framework and said lid is releasably adherable thereto.

16. The separately vendible resealing means of claim 6, wherein said multiuse contact adhesive is provided at least around the perimeter of said lid allowing said lid to be attachable to said framework thereby.

17. The separately vendible resealing means of claim 1, wherein the contents of the sachet are selectable from the group comprising wet wipes, tissues, breakfast cereal, soup powder, dried pasta, spices, legumes, foodstuffs, flakes of soap, flakes of detergent and snack-foods.

18. A method of converting a previously purchased hermetically sealed sachet into a reusable container by the steps of:
(b) retrofitting a separately purchased self-adhesive framework to a surface thereof by adhesion;
(d) forming an aperture in the surface of the sachet within the framework, and
(e) applying a lid to the framework to cover and seal the aperture.

19. The method of claim 18, comprising an initial step (a), prior to said step (b), of either: (i) removing a release layer from said framework to expose a self adhesive layer thereof and/or (ii) activating a self adhesive layer of the framework by dampening.

20. (canceled)

21. The method of claim 18, comprising an additional step (c), prior to said step (d), of either (i) pealing back the lid from the framework to allow formation of an aperture in the surface of the sachet thereunder and/or removing a release layer from said framework to expose self adhesive layer thereof.

22. (canceled)
